(19) United States
(12) Patent Application Publication
(10) Pub. No.: US 2014/0037887 A1
(43) Pub. Date: Feb. 6, 2014

(54) Printable Polypropylene Slip Film and Laminate Packaging

(71) Applicant: Eric W. BENDER, Fairport, NY (US)

(72) Inventor: Eric W. BENDER, Fairport, NY (US)

(21) Appl. No.: 13/567,339

(22) Filed: Aug. 6, 2012

(51) Int. Cl. B32B 9/04; B32B 5/00; B32B 33/00; B29C 63/02; B26D 7/27; C09J 5/00; B29C 47/06; B32B 5/02; B32B 7/12

(52) U.S. Cl. 428/76; 428/447; 428/323; 428/336; 428/195.1; 428/354; 53/396; 156/306.9; 264/173.14; 156/184

(57) ABSTRACT

A flexible, low haze multi-layer film comprising a print skin layer; a slip skin layer comprising from 0.5 wt % to 10 wt % of a surface cross-linked oil or gum polyalkylsiloxane; and a core layer comprising polypropylene between the skin layers; wherein the oily polyalkylsiloxane may have a viscosity within the range of from 10,000 to 100,000 cSt (25° C.) when not cross-linked; or wherein the gum polyalkylsiloxane may have a viscosity within the range of from 1,000,000 to 50,000,000 cSt (25° C.) when not cross-linked. Such multi-layered film can be adhered on the print skin layer side to an adhesive substrate, wherein the adhesive substrate comprises a cold seal adhesive opposite the multi-layer film to form a laminate packaging.

### FIELD OF THE INVENTION

The present disclosure relates in general to multi-layered flexible films capable of releasing from adhesive-containing substrates (“adhesive substrate”), and, in particular, to a multi-layered flexible film that is printable on one side while non-blocking on the other side to facilitate rolling the multi-layered film such that it readily releases from an adhesive substrate.

### BACKGROUND OF THE INVENTION

“Blocking” is the unwanted adhesion between layers of plastic film that may occur under pressure, usually during storage or use. It is known that blocking can be prevented with the use of anti-blocking agents which are added to the composition which makes-up the surface layer of the film. Known anti-blocking additives for plastic packaging film include synthetic waxes. In U.S. Pat. No. 4,692,379, various anti-blocking agents for a heat sealable outer skin of a multilayer film are specifically described, including silica, clay, talc, glass, and other compounds and materials in a particulate form that does not “dissolve” in the polymer matrix in which it is added.

Sealable coatings used on flexible packaging films so that the films can be sealed with the application of pressure and with or without exposure to elevated temperatures can pose blocking problems. A typical cold seal coating is natural or synthetic rubber latex which tends to be tacky at room temperature and causes blocking. The rubber component permits sealing with slight pressure and without using heat. The cold seal coating is usually applied to a plastic film as it is wound into a roll. Since the cold seal coatings are tacky, it is important that the backside of the film which contacts the cold seal coating upon winding does not stick (block) to the cold seal coating so that the film can be easily unwound for use on packaging equipment.

One approach for reduced blocking between the cold seal coating and the backside of the film has been to formulate a cold seal coating which is non-blocking to certain surfaces including polypropylene, such a cold seal formulation is described in U.S. Pat. No. 5,616,400. Another approach uses a cold seal release material on the layer opposite the cold seal surface, see U.S. Pat. Nos. 5,482,780; 5,489,473 and 5,466,734. Other disclosures related to films that incorporate silicon compounds as an anti-block agent include U.S. Pat. Nos. 6,074,762; 6,472,077; 6,576,329; 6,703,141; 6,828,013; 6,824,878; and 8,105,680.

Polyalkylsiloxanes (“PAS”) are useful anti-blocking agents. The problem with these agents, however, is that they tend to transfer to other surfaces they are in contact with so that even if the PAS is first introduced in a slip skin layer that is opposite of the printable layer, at least some of the PAS eventually transfers to the printable skin layer and creates problems for printing. Additional problems created by the use of certain anti-block agents are the increase in film haze when a clear film is desired. What is needed is a way to use PAS as an anti-block agent but without the detrimental effects. The inventor has solved these problems here.

### SUMMARY OF THE INVENTION

These and other problems are solved by providing in part a flexible, preferably low haze multi-layer film comprising a print skin layer; a slip skin layer comprising from 0.5 wt % to 10 wt % of a surface cross-linked oil or gum PAS; and a core layer comprising polypropylene between the skin layers; wherein the oil PAS may have a viscosity within the range of from 10,000 to 100,000 cSt (25° C.) when not cross-linked; or wherein the gum PAS may have a viscosity within the range of from 1,000,000 to 50,000,000 cSt (25° C.) when not cross-linked. Such multi-layered films can be adhered on the print skin layer side to an adhesive substrate, wherein the adhesive substrate comprises a cold seal adhesive opposite the multi-layer film to form a laminate packaging.

An aspect of the invention is a multi-layer film comprising a print skin layer; a slip skin layer comprising a base resin and from 0.5 wt % or 1 wt % to 2 wt % or 4 wt % or 8 wt % or 10 wt % of a PAS that is surface cross-linked; and a core layer comprising polypropylene between the skin layers. The PAS may have a viscosity within the range of from 10,000 or 30,000 or 40,000 to 70,000 or 80,000 or 100,000 cSt (25° C.) when not cross-linked, and is present in the slip layer within the range from 0.5 wt % or 1.0 wt % or 1.5 wt % to 2.0 wt % or 3.0 wt % based on the total weight of the slip skin layer. Alternatively, the PAS may have a viscosity within the range of from 1,000,000 or 5,000,000 or 8,000,000 to 12,000,000 or 20,000,000 or 30,000,000 or 50,000,000 cSt (25° C.) when not cross-linked, and is present in the slip layer within the range from 2.0 wt % to 3.0 wt % or 4.0 wt % or 5.0 wt % based on the total weight of the slip skin layer.

Another aspect of the invention is a method of forming a multi-layer film comprising co-extruding or laminating a print skin layer and a slip skin layer on either side of a polypropylene core layer, the slip skin layer comprising a base resin and from 0.5 wt % or 1 wt % to 2 wt % or 4 wt % or 8 wt % or 10 wt % of a PAS that is surface cross-linkable; effecting the cross-linking of the PAS in the slip skin layer so that the print skin layer comprises from less than 3 wt % or 2 wt % or 1 wt % or 0.5 wt % PAS. The method may further comprise adhering on the print skin layer side of the multi-layer film an adhesive substrate, wherein the adhesive substrate comprises a cold seal adhesive opposite the multi-layer film to form a laminate packaging.

The various descriptive elements and numerical ranges disclosed herein for the multi-layered film or method of making the multi-layered film and laminate packaging can be combined with other descriptive elements and numerical ranges to describe the invention(s); further, for a given element, any upper numerical limit can be combined with any lower numerical limit described herein.

### BRIEF DESCRIPTION OF THE DRAWINGS

FIG. 1 is a bar graph showing the cold seal release values for various laminate packaging that incorporates the inventive multi-layered films.

FIG. 2 is a cross-sectional drawing depicting an example of the inventive multi-layered film that includes the slip skin layer that will come into contact with the adhesive of another material such as an adhesive substrate.

FIG. 3 is a cross-sectional drawing depicting an example of a laminate packaging made from the inventive multi-layered film and an adhesive substrate.

### DETAILED DESCRIPTION

The inventor provides a printable multi-layered film that preferably has low haze, is flexible, and is sealable while having desirable anti-blocking properties when wound against an adhesive-containing substrate. This is accomplished by providing a multi-layered film with at least a slip skin layer, a printable skin layer, and a polypropylene core layer therebetween. The slip skin layer is a homogeneous blend of some base polymer such as a polyethylene, propylene-ethylene copolymer, or propylene-ethylene-butylene terpolymer and a PAS that is either an oil or gum form. The PAS, once “dissolved” in the slip skin polymer, is at least surface cross-linked to inhibit its transfer to the print skin layer. Furthermore, the level of the PAS present in the slip skin layer is adjusted to provide an optimal release surface with minimal transfer of the PAS to other surfaces. Desirably, particulate anti-block agents (present as “fine particles”) are substantially absent, meaning that they are not present to any measurable extent, or if present, exist in the slip skin layer to a level of less than 1 wt % or 0.5 wt % or 0.1 wt % or 0.05 wt % of the total slip skin layer. The “fine particles” are materials having an average particle size within the range from 0.1 μm or 0.5 μm or 1 μm to 3 μm or 5 μm or 10 μm, or less than 10 μm or 5 μm, that do not dissolve in the skin layer base materials and thus form a heterogeneous blend. At a low enough level, such fine particles do not negatively influence the clarity (haze) of the film, but may at higher levels.

Preferably, the multi-layered films of the invention have at least 3 layers, more preferably at least 4 layers, and most preferably at least 5 layers. The multi-layer films typically have one, more preferably at least two skin layers that are bound to a tie-layer on one face, and are unbound (face away from the multi-layer film) on the other face. In other embodiments, there is a tie-layer between each core layer and each skin layer that are otherwise adjacent to one another in the structure. If each skin layer is labeled “S”, each core layer labeled “C”, and each tie-layer labeled “T”, then preferable film structures include, but are not limited to, SCS, STCS, STCTS, SSTCS, STSCTSTS, SSTCCTSS, STSTCCTSTS, STTCTTS, SSSTCTS, SSTCTS, SCCCS, and other such structures. In the films described herein, each individual skin layer may be the same or different in composition compared to other skin layers in the same film. Also, each core layer may be the same or different and each tie-layer may be the same or different. Thus, for example, preferable multi-layer film structures are represented by S¹T¹S², S¹T¹CS², S¹T¹CT²S², S¹S²T¹CT²S¹, S¹C¹C²C³S², etc., wherein “S¹” and “S²” are distinct from one another, meaning that they comprise different materials, and/or the same materials but in different ratios; the same is true for “T¹” and “T²”, and for C¹, C², etc. Preferably, in the present invention, S¹ is a printable skin layer (or “print” skin layer) and S² is the slip skin layer, and there is at least one core layer of material. However, each skin layer, tie-layer, and core layer that makes up a film may have a similar or identical identity, as this type of structure would allow the use of only three extruders to melt blend and extrude the materials that form each layer of the multi-layer film. As used throughout, the term “between”, when used to refer to the location of a film layer relative to other layers, does not exclude the possibility that additional layers may also be “between” the referenced layers.

As used herein, the term “layer” refers to each of the one or more materials, the same or different, that are secured to one another in the form of a thin sheet or film by any appropriate means such as by an inherent tendency of the materials to adhere to one another, or by inducing the materials to adhere as by a heating, radiative, chemical, or some other appropriate process. The term “layer” is not limited to detectable, discrete materials contacting one another such that a distinct boundary exists between the materials. Preferably, however, the materials used to make one layer of a film will be different (i.e., the weight percent of components, the properties of each component, and/or the identity of the components may differ) from the materials used to make an adjacent, and adhering, layer. The term “layer” includes a finished product having a continuum of materials throughout its thickness. The “films” described herein comprise three or more layers, and may comprise 3, 4, 5, 6, or more layers in preferred embodiments.

The PAS is said to be “surface” cross-linked, meaning that the molecules that reach the outer surface of a film layer are cross-linked and not necessarily all the molecules throughout the film layer. However, for film layers approaching a value of less than 2 μm, a treatment that effects surface cross-linking may cross-link up to 60 wt % or 70 wt % or 80 wt % or 90 wt % or 95 wt % or 99 wt % of the PAS in that layer. Cross-linking is effected by treating at least the surface of the slip skin layer using coronal, plasma, heat, or other ion source to a measured CAHN level of at least 0.30 or 0.32 or 0.35 or 0.40, or, alternatively, to within a range of from 0.30 or 0.32 or 0.35 to 0.50 or 0.60 or 0.70. Such “treatments” are known in the art for treating the surfaces of films and any one or combination may be used.

The 3, 4, 5, 6, or more layer film structures (films) of the invention may be any desirable thickness, and preferably have an average thickness within the range of from 10 μm or 20 μm or 30 μm or 40 μm to an upper limit of 50 μm or 60 μm or 80 μm or 100 μm or 150 μm or 200 μm or 500 μm. Thus, an exemplary average thickness is within the range of from 10 μm to 50 μm. Preferably, the slip skin layer has an average thickness within the range of from 400 nm or 500 nm or 600 nm to 800 nm or 900 nm or 1000 nm.

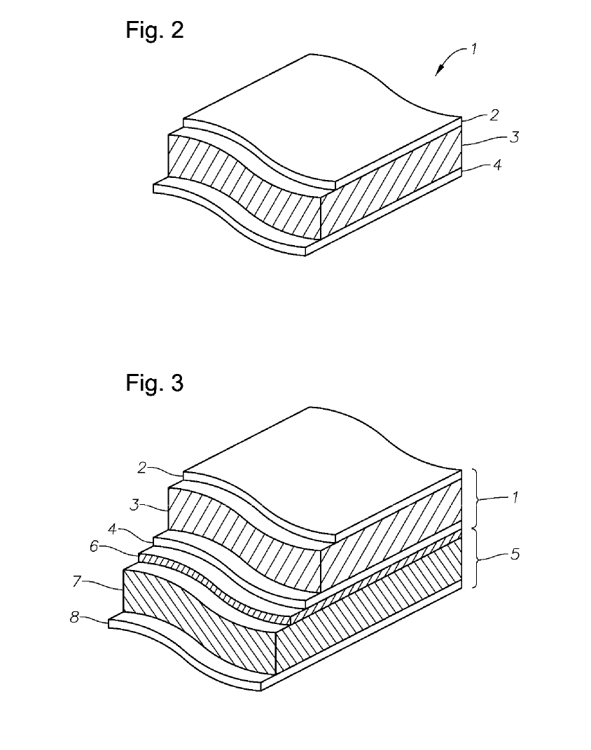

The drawing in FIG. 2 is a cross-sectional representation of an embodiment of the multi-layered films of the invention. The multi-layer film 1 is made up of three layers: the slip skin layer 2, the core layer 3, and the print skin layer 4; the core layer 3 being between the layers 2 and 4. Other layers could also be present such as additional skin or tie layers between the skin layers 2 and/or 4 and the core layer 3. This multi-layered film can be adhered to a substrate with adhesive or other means, or the substrate itself may have an adhesive thereon, collectively referred to as an “adhesive substrate”. An embodiment of the adhesive substrate 5 bound to the multi-layered film 1 is shown in FIG. 3. The adhesive substrate 5 is made up of an adhesive 6, the substrate 7, and a cold seal adhesive 8, the substrate 7 between the adhesive 6 and cold seal adhesive 8. The “substrate” 7 can be made of any desirable material or layers of materials such as polymers, cellulosic based materials, or other known materials that are preferably flexible and strong. The “adhesives” can be any type of adhesives known in the art that are suitable for adapting the multi-layered film suitable as a label or packaging for an article. The combination of the multi-layered film 1 and adhesive substrate 5 forms the laminate packaging.

When transported, the laminate packaging is rolled onto itself around a spindle (or equivalent) such that the slip skin layer 2 comes into contact with the cold seal adhesive 8 of the section that is rolled around the spindle. The inventive multi-layered film is designed so that the amount of force necessary to unwind the roll of film once it reaches its destination is minimal and there is no tearing of the laminate packaging. Preferably, the laminate packaging is unrolled with a cold seal release force of less than 150 g/in (59 g/cm) or 120 g/in (47 g/cm) or 100 g/in (39 g/cm) or 80 g/in (31 g/cm) or 50 g/in (17 g/cm), or between 50 (17) and 150 g/in (59 g/cm). Ideally, the laminate packaging is unrolled and fed to an apparatus that forms packages around articles, especially food articles. In particular, the laminate packaging is preferably fed to a VFFS or HFFS apparatus to package an article. Ideally, any printing will be on the print skin 4 such that it will be visible through the multi-layered film to the user who is looking through the multi-layered film 1 from the slip skin 2 face.

Described more broadly, the multi-layer films of the invention comprise (or consist essentially of, or consist of) a print skin layer, a slip skin layer comprising a base resin and from 0.5 wt % or 1 wt % to 2 wt % or 4 wt % or 8 wt % or 10 wt % of an oil or gum PAS that is surface cross-linked, and a core layer comprising polypropylene between the skin layers. The multi-layered film may comprise any number of other layers such as additional skin layers and/or tie-layers between the skin layers and core layer.

The PAS can be of two types, one that is an oil and another that is a gum, wherein the gum is typically blended with a polyolefin, especially polypropylene, and used as the polyolefin/PAS blend. The oil PAS has a viscosity within the range of from 10,000 or 30,000 or 40,000 to 70,000 or 80,000 or 100,000 cSt (25° C.) when not cross-linked, and is most preferably present in the slip layer within the range from 0.5 wt % or 1.0 wt % or 1.5 wt % to 2.0 wt % or 3.0 wt % based on the total weight of the slip skin layer. The gum PAS has a viscosity within the range of from 1,000,000 or 5,000,000 or 8,000,000 to 12,000,000 or 20,000,000 or 30,000,000 or 50,000,000 cSt (25° C.) when not cross-linked, and is preferably present in the slip layer within the range from 2.0 wt % to 3.0 wt % or 4.0 wt % or 5.0 wt % based on the total weight of the slip skin layer. The PAS—gum or oil—that is useful in the invention is such that it forms a homogeneous blend with the base resin, or at least does not increase, the haze by any more than 2% to 6%. The slip skin layer comprises within the range of from 90 wt % or 95 wt % to 96 wt % or 97 wt % or 98 wt % or 98.8 wt % or 99.0 wt % or 99.5 wt % of the base resin. The base resin can be most any polyolefin or other polymer capable of forming a clear surface through which printing can be seen, but the base resin is preferably selected from the group consisting of ethylene-propylene copolymer, ethylene-propylene-butylene terpolymer, a polyethylene homopolymer, and blends thereof. Most preferably the base resin is one that will most readily dissolve the PAS, in particular, a propylene-ethylene copolymer or propylene-ethylene-butylene terpolymer.

The PAS comprises “alkyl” groups which may or may not be substituted, preferably C₁ to C₁₀ alkyl groups, more preferably C₁ to C₄ alkyl groups, and most preferably the alkyl group is methyl or ethyl. Thus, a preferred embodiment of the PAS is a polydimethylsiloxane. Substitutions on the alkyl group can include vinyl groups, hydroxyl groups, carboxylate groups, carboxyl groups, ester groups, thiol groups, imine or amine groups, or combinations thereof. Some or all of the alky groups may be vinyl groups or other groups known to form cross-links with adjacent PAS molecules or adjacent polymer molecules.

Since at least the slip skin surface is treated (e.g., coronal, plasma, etc.) to effect a cross-linking of the PAS, little to none of the PAS will migrate through the film layers to the print skin surface. Preferably, the surface of the print skin layer comprises from less than 3 wt % or 2 wt % or 1 wt % or 0.5 wt % PAS as measured by the amount of silicon on the surface determined using ESCA measurement, described further below; or alternatively, the silicon on the surface of the print skin layer is within a range of from 0.5 wt % or 1 wt % to 2 wt % or 3 wt %. Without the surface treatment to cross-link the PAS, the amount of silicon measured on the surface of the print skin layer can be greater than 2 wt % or 5 wt % or 10 wt % or 15 wt %, as demonstrated by the inventor in the Examples.

The slip skin layer may further comprise from 0 wt % or 0.1 wt % to 0.3 wt % or 0.5 wt % or 0.7 wt % or 1.0 wt % of fine particles, such as commonly known anti-blocking agents, having an average particle size within the range from 0.1 μm or 0.5 μm or 1 μm to 3 μm or 5 μm or 10 μm, or less than 10 μm or 5 μm; alternatively, wherein fine particles are substantially absent. Some examples of such fine particles are Tospearl™ T120 and T130, Epostar™ MA1002, and Seahostar™ KEP250.

The materials that can make up the base resin of the slip skin, core layers, and print skin layer are described further below; but can be most any material that meets the needs of having a strong, flexible clear film, preferably having a Haze (ASTM D1003) value of less than 10% or 8% or 5% or 3%; alternatively, the film may have a matte appearance as when using, for example, a matte print or slip skin resin. Also, the slip skin layer is such that it should have a low blocking, as mentioned above. The slip skin layer will contain a desirable amount of PAS as described herein and be treated so that less than 15 wt % or 10 wt % or 8 wt % or 5 wt % of the PAS in the slip skin layer migrates from the slip skin layer to the print skin layer. Another criterion for the print skin layer is that it should readily accept printing (e.g., ink). Such materials are well known in the art, the most suitable of which are polyolefin materials or cyclic olefin copolymer materials, either of which may have a coating adhered thereto to promote ink adhesion, and/or which may be treated as by coronal or plasma treatment to effect ink adhesion.

The primary qualification for the print skin layer is that it be made of material, or have a coating or other treatment that makes the surface amendable to printing such as with inks, etc. Such a multi-layered film with printing is desirable to form a laminate packaging comprising the multi-layer film adhered on the print skin layer side of the multi-layer film to an adhesive substrate, wherein the adhesive substrate comprises a cold seal adhesive opposite the multi-layer film.

The base resin for the slip skin layer may be made of similar materials as long as it too is clear, adheres to the underlying layers, and is non-blocking. Preferably, the base resin for the slip skin layer and/or the material used in the print skin layer is selected from the group consisting of ethylene-propylene copolymers (from 3 wt % to 50 wt % copolymer content), ethylene-propylene-butylene terpolymers, a polyethylene homopolymers, propylene copolymers (less than 2 wt % copolymer content), and blends thereof. Particular examples of preferred commercially available resins useful for the slip skin layer and print layer include: XPM-7794 and XPM-7510 both C₂/C₃/C₄ terpolymers available from Japan Polypropylene Corp; 8573HB a C₃/C₂ copolymer available from Total Petrochemical Company; PB0300M and Adsyl™ 3C30FHP available from LyondellBasell; Equistar 6030B polyethylene (PE); Admer™ QF551 maleic anhydride-modified ethylene-propylene copolymer (MAH-g-EP); Total EOD 96-30 syndiotactic polypropylene homopolymer (s-PP); Chisso 3140, an incompatible multipolymer blend (matte) for non-clear embodiments of the invention; and Topas™ 8007F-400 cyclic olefin copolymer (COC). Mixtures of any two or more of these materials may also be used.

The “polypropylene” that is preferably used in the core and other layers is a homopolymer or copolymer comprising from 60 wt % or 70 wt % or 80 wt % or 85 wt % or 90 wt % or 95 wt % or 98 wt % or 99 wt % to 100 wt % propylene-derived units; comprising within the range of from 0 wt % or 1 wt % or 5 wt % to 10 wt % or 15 wt % or 20 wt % or 30 wt % or 40 wt % C₂ and/or C₄ to C₁₀ α-olefin derived units; and can be made by any desirable process using any desirable catalyst as is known in the art, such as a Ziegler-Natta catalyst, a metallocene catalyst, or other single-site catalyst, using solution, slurry, high pressure, or gas phase processes. Certain polypropylenes that find use as the core layer have within the range from 0.2 wt % or 0.5 wt % to 1 wt % or 2 wt % or 5 wt % ethylene-derived units. Polypropylene copolymers are useful polymers in certain embodiments, especially copolymers of propylene with ethylene and/or butene, and comprise propylene-derived units within the range of from 70 wt % or 80 wt % to 95 wt % or 98 wt % by weight of the polypropylene. In any case, useful polypropylenes have a DSC melting point (ASTM D3418) of at least 125° C. or 130° C. or 140° C. or 150° C. or 160° C., or within a range of from 125° C. or 130° C. to 140° C. or 150° C. or 160° C. A “highly crystalline” polypropylene is preferred in certain embodiments of the inventive films, and is typically isotactic and comprises 100 wt % propylene-derived units (propylene homopolymer) and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter- and intra-molecular order. Preferably, the polypropylene has a heat of fusion (H_{f}) greater than 60 J/g or 70 J/g or 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer. Also, the polypropylenes useful in the inventive films may have a glass transition temperature (ISO 11357-1, Tg) preferably between −20° C. or −10° C. or 0° C. to 10° C. or 20° C. or 40° C. or 50° C. Preferably, the polypropylenes have a Vicat softening temperature (ISO 306, or ASTM D 1525) of greater than 120° C. or 110° C. or 105° C. or 100° C., or within a range of from 100° C. or 105° C. to 110° C. or 120° C. or 140° C. or 150° C., or a particular range of from 110° C. or 120° C. to 150° C.

Preferably, the polypropylene has a melt flow rate (“MFR”, 230° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0 in certain embodiments. Suitable grades of polypropylene that are useful in the oriented films described herein include those made by ExxonMobil, LyondellBasell, Total, Borealis, Japan Polypropylene, Mitsui, and other sources.

The multi-layer film can be formed by any process known to those of skill in the art. Preferably, the various layers are coextruded and oriented; most preferably at least once in the MD and once in the TD; optionally, again in the MD. Broadly, the method of forming a multi-layer film comprises co-extruding or laminating a print skin layer and a slip skin layer on either side of a polypropylene core layer; the slip skin layer comprising a base resin and from 0.5 wt % or 1 wt % to 2 wt % or 4 wt % or 8 wt % or 10 wt % of an oil or gum PAS that is surface cross-linkable; effecting the cross-linking of the PAS in the slip skin layer so that the print skin layer comprises from less than 3 wt % or 2 wt % or 1 wt % or 0.5 wt % PAS. Cross-linking is effected by treating at least the surface of the slip skin layer using coronal, plasma, heat, or ion source to a CAHN level of at least 0.30 or 0.32 or 0.35 or 0.40. Most any power density can be used as long as the desired CAHN level is reached.

It is desirable to use the multi-layered film as one component in packaging material. To this end, the invention further comprises adhering onto the print skin layer side of the multi-layer film an adhesive substrate, wherein the adhesive substrate comprises a cold seal adhesive opposite the multi-layer film to form a laminate packaging. The cold seal adhesive can be any adhesive known in the art, especially those known to be useful for sealing/adhering materials at temperatures between 0° C. and 30° C. Most such adhesives contain natural or synthetic rubber or “latex” as is known in the art.

Desirably, the laminate packaging can be formed into a roll such that the slip skin layer is continuously in contact with the cold seal adhesive. The laminate packaging of the invention can be unrolled with a cold seal release force of less than 150 g/in or 120 g/in or 100 g/in or 80 g/in or 50 g/in. Desirably, the inventive laminate packaging can be fed to a vertical or horizontal (VFFS or HFFS) apparatus to package an article. The multi-layered film could also be used for other purposes, especially when combined with an adhesive substrate to form, for example, bandages, dressings, and other medical uses, securing tape, labeling, envelopes, and other non-packaging uses.

### EXAMPLES

### Example 1

The first set of lab-scale experiments demonstrates the advantages of a UHMW polyalkylsiloxane (“PAS”) in a slip skin of a multi-layered film. The test films were three-layer films having a slip layer, a core layer, and a print skin layer. The print skin is Total 8573HB, an EP copolymer. The core resin is ExxonMobil 4712 polypropylene homopolymer and is made up of three layers of the same material. Various primary components for the slip skin were tested, as summarized in Table 1. The print and slip skins are corona treated to obtain a minimum CAHN (receding cosine of the contact angle) value of 0.70 for the print skin and 0.30 for the slip skin.

Slip skin formulation: the base resins are ExxonMobil 4712 polypropylene homopolymer (PP), Equistar 6030B polyethylene (PE), Total 8573 HB ethylene-propylene copolymer (EP Copo), Admer™ QF551 maleic anhydride-modified ethylene-propylene copolymer (MAH-g-EP), Total EOD 96-30 syndiotactic polypropylene homopolymer (s-PP), Chisso (now Japan Polypropylene Corp.) 7510 ethylene-propylene-butylene terpolymer (EPB terpo), Chisso 3140 an incompatible multi-polymer blend (matte), and Topas™ 8007F-400 cyclic olefin copolymer (COC). The polyalkylsiloxane is Dow Corning™ MB50-001, 10,000,000 to 50,000,000 cSt (gum) and Dow Corning 200, 60,000 cSt (oil). The anti-block is Tospearl™ T120, Tospearl™ T130, Epostar™ MA1002, and Seahostar™ KEP250.

The percent (%) Si on the slip skin and print skin were measured by Electron Spectroscopy Chemical Analysis (ESCA) on a Perkin-Elmer PHI 5600, using the operating procedure provided with the instrument, and recorded in Table 1. A monochromatic Aluminum (Al) source (Al Kα radiation at 1486.6 eV (electron-volts)) and a take-off angle of 45° were used in ESCA measurements. Spectra are referenced with respect to a calibration level of 285.0 eV for the carbons in hydrocarbons. From the XPS spectra obtained, the Carbon (C), Oxygen (O), and Silicon (Si) atomic percentage is measured. Less than 3% Si is desired on the print skin for good print performance. Greater than 10% Si is desired on the slip skin for good release performance. For Examples 1-15, the samples were wound in a roll for at least a week before testing the amount of silicone on both surfaces.

Some conclusions for lab-scale experiments can be drawn from the data presented in Table 1. Examples 1 and 2 show that when PAS is added to a PP skin resin, the amount of Si that is on the slip surface is low, resulting in poor release values to cold seal. Examples 3 through 9 compare different designs utilizing a PE skin with PAS. Examples 3, 7, 8, and 9 compare different amounts of PAS in the skin compound. While 2.0%, 2.5%, and 3.0% result in acceptable amounts of Si on both surfaces for good print and slip performance, Example 3 falls outside the invention, due to the expected poor print performance based on the high amount of Si that transferred to the print surface.

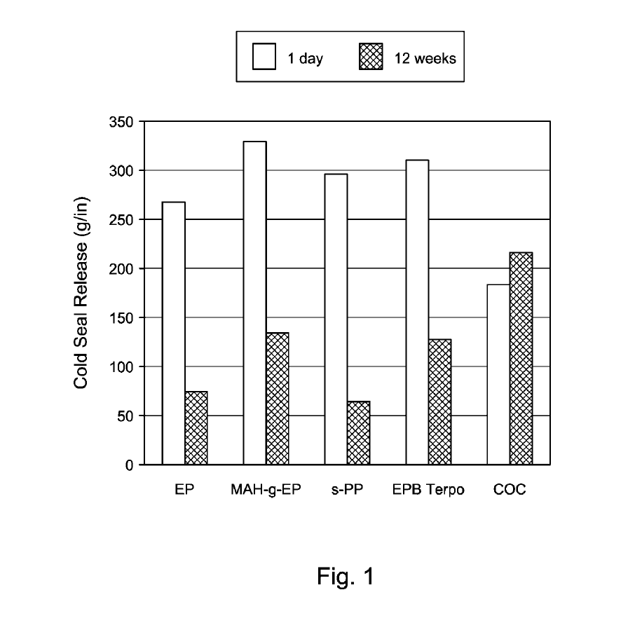

Examples 4 and 7 compare using gum versus oil (60,000 cSt). Oil tends to transfer at greater amounts to the print surface. Therefore, silicon gum must be used at higher concentrations than silicone oil in order to obtain similar slip performance. Examples 5 and 7 compare the effectiveness of treating the PAS. Coronal treatment prevents the PAS transfer to the print surface and also reduces the cold seal release force. Therefore treatment is advantageous for this invention. Examples 6 and 7 compare the thickness of the slip skin. While both designs would be effective, the thinner skin (0.75 μm) results in higher Si species at the slip surface, thus, providing better release. Anti-block can be used to provide separation between the slip surface and the print surface to reduce the contact and, subsequently, the transfer of silicon between surfaces. While Examples 3-9 all used anti-block particles, there was no specific advantage found by using a certain type or quantity of anti-block. Examples 10-15 show that other types of slip skin resins can act as carrier resins for the PAS, resulting in good release surfaces with low amounts of Si transfer to the print surface. FIG. 1 summarizes the results of release testing one day after production and aged for 12 weeks for different base resins in the slip skin, showing that release values for most slip skins improve over time.

### Example 2

The second set of pilot-scale experiments demonstrates the advantages of a lower molecular weight PAS oils (60,000 cSt) in a slip skin of a multi-layered film. Compared to the higher molecular weight PAS, a lower concentration of oil is used to obtain the desired slip and printing performance. Examples 16-19 demonstrate the optimal range of silicone oil in an EP copolymer skin to be 1.2% to 3.0%, more preferably 1.5% to 1.8%.

TABLE 1
Example 1 films with UHMW polyalkylsiloxane slip additive

| | Slip Skin | | | | | | | | | |
|---|---|---|---|---|---|---|---|---|---|---|
| | Base slip | | | | | slip skin | % Si | % Si | % | release |
| Example | resin | % PAS | PAS Type | Anti-block | Treatment | thickness | print | slip | transfer | g/in |
| 1 | PP | 0.7 | gum | 0.2% T120 | No | 0.75 μm | 1.3 | 0.5 | 72 | 196 |
| 2 | PP | 3.0 | gum | None | Yes | 0.75 μm | 0.8 | 5.1 | 14 | 107 |
| 3 | PE | 4.0 | gum | 0.4% T120 | Yes | 0.75 μm | 6.6 | 20.0 | 25 | 23 |
| 4 | PE | 2.5 | oil | 0.3% T130 | Yes | 0.75 μm | 6.9 | 21.4 | 24 | 35 |
| 5 | PE | 2.5 | gum | 0.3% T130 | No | 0.75 μm | 17.8 | 14.1 | 56 | 599 |
| 6 | PE | 2.5 | gum | 0.3% T130 | Yes | 1.50 μm | 2.1 | 13.7 | 13 | 68 |
| 7 | PE | 2.5 | gum | 0.3% T130 | Yes | 0.75 μm | 1.8 | 19.0 | 9 | 40 |
| 8 | PE | 2.0 | gum | 0.2% T120 | Yes | 0.75 μm | 1.5 | 16.2 | 8 | 44 |
| 9 | PE | 3.0 | gum | 0.2% MA1002 | Yes | 0.75 μm | 2.8 | 20.9 | 12 | 79 |
| 10 | EP copo | 3.0 | gum | None | Yes | 0.75 μm | 1.4 | 14.6 | 9 | 76 |
| 11 | MAH-g-EP | 3.0 | gum | None | Yes | 0.75 μm | 0.7 | 13.1 | 5 | 134 |
| 12 | s-PP | 3.0 | gum | None | Yes | 0.75 μm | 1.6 | 15.0 | 10 | 65 |
| 13 | EPB terpo | 3.0 | gum | None | Yes | 0.75 μm | 1.6 | 14.0 | 10 | 127 |
| 14 | Matte | 4.0 | gum | None | Yes | 0.75 μm | 1.5 | 22.3 | 6 | 32 |
| 15 | COC | 3.0 | gum | None | Yes | 0.75 μm | 0.6 | 13.5 | 4 | 216 |
| 16 | EP Copo | 1.2 | oil | 0.06% MA1002 | Yes | 0.75 μm | 0.4 | 13.8 | 3 | 69 |
| 17 | EP Copo | 1.5 | oil | 0.075% MA1002 | Yes | 0.75 μm | 0.5 | 15.3 | 3 | 56 |
| 18 | EP Copo | 1.8 | oil | 0.09% MA1002 | Yes | 0.75 μm | 0.7 | 16.3 | 4 | 51 |
| 19 | EP Copo | 3.0 | oil | 0.15% MA1002 | Yes | 0.75 μm | 1.9 | 20.9 | 9 | 32 |

Having described the various aspects of the multi-layered films and packaging laminates and methods of making these films and laminates, disclosed here in numbered embodiments is:
1. A multi-layer film comprising (or consisting essentially of, or consisting of):
   a print skin layer;
   a slip skin layer comprising a base resin and from 0.5 wt % or 1 wt % to 2 wt % or 4 wt % or 8 wt % or 10 wt % of an oil or gum polyalkylsiloxane that is surface cross-linked; and
   a core layer comprising polypropylene between the skin layers.
2. The multi-layer film of numbered embodiment 1, wherein the oil polyalkylsiloxane has a viscosity within the range of from 10,000 or 30,000 or 40,000 to 70,000 or 80,000 or 100,000 cSt (25° C.) when not cross-linked and is present in the slip layer within the range from 0.5 wt % or wt % 1.0 wt % or 1.5 wt % to 2.0 wt % or 3.0 wt %, based on the total weight of the slip skin layer.
3. The multi-layer film of numbered embodiment 1 or 2, wherein the gum polyalkylsiloxane has a viscosity within the range of from 1,000,000 or 5,000,000 or 8,000,000 to 12,000,000 or 20,000,000 or 30,000,000 or 50,000,000 cSt (25° C.) when not cross-linked and is present in the slip layer within the range from 2.0 wt % to 3.0 wt % or 4.0 wt % or 5.0 wt %, based on the total weight of the slip skin layer.
4. The multi-layer film of any one of the previous numbered embodiments, wherein the slip skin layer comprises from 90 wt % to 98.8 wt % of the base resin; wherein the base resin is selected from the group consisting of ethylene-propylene copolymer, ethylene-propylene-butylene terpolymer, a polyethylene homopolymer, and blends thereof
5. The multi-layer film of any one of the previous numbered embodiments, wherein the surface of the print skin layer comprises from less than 3 wt % or 2 wt % or 1 wt % or 0.5 wt % silicon (as measured by ESCA) or within a range of from 0.5 wt % or 1 wt % to 2 wt % or 3 wt %.
6. The multi-layer film of any one of the previous numbered embodiments, wherein the slip skin layer further comprises from 0 wt % or 0.1 wt % to 0.3 wt % or 0.5 wt % or 0.7 wt % or 1.0 wt % of fine particles having an average particle size within the range from 0.1 μm or 0.5 μm or 1 μm to 3 μm or 5 μm or 10 μm, or less than 10 μm or 5 μm; alternatively, wherein fine particles are substantially absent.
7. The multi-layer film of any one of the previous numbered embodiments, wherein the slip skin layer has an average thickness within the range of from 400 nm or 500 nm or 600 nm to 800 nm or 900 nm or 1000 nm.
8. The multi-layer film of any one of the previous numbered embodiments, having a Haze (ASTM D1003) value of less than 10% or 8% or 5% or 3%.
9. The multi-layer film of any one of the previous numbered embodiments, further comprising print on the print skin layer.
10. The multi-layer film of any one of the previous numbered embodiments, wherein less than 15 wt % or 10 wt % or 8 wt % or 5 wt % of the polyalkylsiloxane transfers from the slip skin layer to the print skin layer.
11. A laminate packaging comprising the multi-layer film of any one of the previous numbered embodiments adhered on the print skin layer side of the multi-layer film to an adhesive substrate, wherein the adhesive substrate comprises a cold seal adhesive opposite the multi-layer film.
12. An article wrapped inside the laminate packaging of numbered embodiment 11.
13. A method of forming a multi-layer film comprising:
   co-extruding or laminating a print skin layer and a slip skin layer on either side of a polypropylene core layer to form the multi-layered film of any one of the previous numbered embodiments 1 to 10; and
   effecting the cross-linking of the polyalkylsiloxane in the slip skin layer so that the print skin layer comprises from less than 3 wt % or 2 wt % or 1 wt % or 0.5 wt % polyalkylsiloxane.
14. The method of numbered embodiment 13, further comprising adhering on the print skin layer side of the multi-layer film an adhesive substrate, wherein the adhesive substrate comprises a cold seal adhesive opposite the multi-layer film to form a laminate packaging.
15. The method of numbered embodiment 14, further comprising rolling the laminate packaging into a roll such that the slip skin layer is continuously in contact with the cold seal adhesive.
16. The method of embodiment number 15, wherein the laminate packaging is unrolled with a cold seal release force of less than 150 g/in (59 g/cm) or 120 g/in (47 g/cm) or 100 g/in (39 g/cm) or 80 g/in (31 g/cm) or 50 g/in (17 g/cm).

The invention also includes the use of the multi-layered film and/or the laminate packaging that comprises the multi-layered film of any one of the numbered embodiments 1 to 10 in the packaging of articles.

By “consisting essentially of” in numbered embodiment 1, what is meant is that the multi-layered film may include one or more tie-layers between the core and skin layers, and the core and skin layers may include other additives as is known in the art as long as the claimed properties are not altered such that they fall outside the scope of those claimed properties; and by “consisting of” what is meant is that the multi-layered film includes only the three layers and additives, as is known in the art, to a level no greater than 1 wt % or 2 wt % or 3 wt % of the total weight of materials in a given film layer, or alternatively, additives are not measurably present. The “additives” include colorants, whitening agents, cavitation agents, antioxidants, anti-slip agents, antifogging agents, nucleating agents, and other additives common in the flexible packaging film arts. Preferably, anti-blocking agents other than the claimed PAS are absent from the slip layer of the inventive multi-layered films.

1. A multi-layer film comprising:
a print skin layer;
a slip skin layer comprising a base resin and from 0.5 wt % to 10 wt % of an oil or gum polyalkylsiloxane that is surface cross-linked; and
a core layer comprising polypropylene between the skin layers.

2. The multi-layer film of claim 1, wherein the oil polyalkylsiloxane has a viscosity within the range of from 10,000 to 100,000 cSt (25° C.) when not cross-linked and is present in the slip layer within the range from 0.5 wt % to 3.0 wt %, based on the total weight of the slip skin layer.

3. The multi-layer film of claim 1, wherein the gum polyalkylsiloxane has a viscosity within the range of from 1,000,000 to 50,000,000 cSt (25° C.) when not cross-linked and is present in the slip layer within the range from 2.0 wt % to 5.0 wt %, based on the total weight of the slip skin layer.

4. The multi-layer film of claim 1, wherein the slip skin layer comprises from 90 wt % to 98.8 wt % of the base resin; wherein the base resin is selected from the group consisting of ethylene-propylene copolymer, ethylene-propylene-butylene terpolymer, a polyethylene homopolymer, and blends thereof.

5. The multi-layer film of claim 1, wherein the surface of the print skin layer comprises from less than 3 wt % silicon (as measured by ESCA).

6. The multi-layer film of claim 1, wherein the slip skin layer further comprises from 0 wt % to 1.0 wt % of fine particles having an average particle size within the range from 0.1 μm to 10 μm.

7. The multi-layer film of claim 1, wherein the slip skin layer has an average thickness within the range of from 400 nm to 1000 nm.

8. The multi-layer film of claim 1, having a Haze (ASTM D1003) value of less than 10%.

9. The multi-layer film of claim 1, further comprising print on the print skin layer.

10. The multi-layer film of claim 1, wherein less than 15 wt % of the polyalkylsiloxane transfers from the slip skin layer to the print skin layer.

11. A laminate packaging comprising the multi-layer film of claim 1 adhered on the print skin layer side of the multi-layer film to an adhesive substrate, wherein the adhesive substrate comprises a cold seal adhesive opposite the multi-layer film.

12. An article wrapped inside the laminate packaging of claim 11.

13. A method of forming a multi-layer film comprising:
co-extruding or laminating a print skin layer and a slip skin layer on either side of a polypropylene core layer, the slip skin layer comprising a base resin and from 0.5 wt % to 10 wt % of an oil or gum polyalkylsiloxane that is surface cross-linkable; and
effecting the cross-linking of the polyalkylsiloxane in the slip skin layer so that the print skin layer comprises from less than 3 wt % polyalkylsiloxane.

14. The method of claim 13, further comprising adhering on the print skin layer side of the multi-layer film an adhesive substrate, wherein the adhesive substrate comprises a cold seal adhesive opposite the multi-layer film to form a laminate packaging.

15. The method of claim 14, further comprising rolling the laminate packaging into a roll such that the slip skin layer is continuously in contact with the cold seal adhesive.

16. The method of claim 13, wherein the oil polyalkylsiloxane has a viscosity within the range of from 10,000 to 100,000 cSt (25° C.) when not cross-linked and is present in the slip layer within the range from 0.5 wt % to 3.0 wt %, based on the total weight of the slip skin layer.

17. The method of claim 13, wherein the gum polyalkylsiloxane has a viscosity within the range of from 1,000,000 to 50,000,000 cSt (25° C.) when not cross-linked and is present in the slip layer within the range from 2.0 wt % to 5.0 wt %, based on the total weight of the slip skin layer.

18. The method of claim 13, wherein cross-linking is effected by treating at least the surface of the slip skin layer using coronal, plasma, heat, or ion source to a CAHN level of at least 0.30.

19. The method of claim 13, wherein the slip skin layer comprises from 90 wt % to 98.8 wt % of the base resin; wherein the base resin is selected from the group consisting of ethylene-propylene copolymer, ethylene-propylene-butylene terpolymer, a polyethylene homopolymer, and blends thereof.

20. The method of claim 13, wherein the surface of the print skin layer comprises from less than 3 wt % silicon (as measured by ESCA).

21. The method of claim 13, wherein the slip skin layer further comprises from 0 wt % or to 1.0 wt % of fine particles having an average particle size within the range from 0.1 μm to 10 μm.

22. The method of claim 13, wherein the slip skin layer has an average thickness within the range of from 400 nm to 1000 nm.

23. The method of claim 13, having a Haze (ASTM D1003) value of less than 10%.

24. The method of claim 13, further comprising print on the print skin layer.

25. The method of claim 15, wherein the laminate packaging is unrolled with a cold seal release force of less than 150 g/in (59 g/cm).

26. The method of claim 15, wherein the laminate packaging is fed to a VFFS or HFFS apparatus to package an article.
